(19) United States
(12) Patent Application Publication
(10) Pub. No.: US 2006/0243714 A1
(43) Pub. Date: Nov. 2, 2006

(54) Selective processing of laminated target by laser

(75) Inventors: Shiro Hamada, Yokosuka (JP); Tomoyuki Yamaguchi, Yokosuka (JP); Jiro Yamamoto, Chigasaki Chigasaki-shi (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: SUMITOMO HEAVY INDUSTRIES, LTD.

(21) Appl. No.: 11/370,895

(22) Filed: Mar. 9, 2006

Related U.S. Application Data
(63) Continuation of application No. PCT/JP03/11530, filed on Sep. 9, 2003.

(51) Int. Cl. B23K 26/38

(52) U.S. Cl. 219/121.69; 219/121.68; 264/400

(57) ABSTRACT

A laser processing method has the steps of: (a) irradiating a laser beam from a laser source; and (b) applying the laser beam irradiated from the laser source to a first surface area of a processing object having a resin layer and a transparent conductive layer made of metal oxide and formed on the surface of the resin layer, to remove the transparent conductive layer and form a concave portion exposing the resist layer on the bottom of the first concave portion.

### CROSS REFERENCE TO RELATED APPLICATION

This application is a continuation application of PCT/JP03/011530, filed on Sep. 9, 2003, which is incorporated herein by reference.

### BACKGROUND OF THE INVENTION

A) Field of the Invention

The present invention relates to a laser processing method and apparatus, and more particularly to a laser processing method and apparatus capable of processing a transparent conductive layer made of metal oxide.

B) Description of the Related Art

There is a substrate having color filters made of a resin layer formed on the surface of a glass base and a transparent conductive layer made of metal oxide such as indium tin oxide (ITO) and formed on the surface of the color filters. This substrate is used, for example, for a liquid crystal display.

Transparent electrodes for applying voltage to liquid crystal are formed by leaving a transparent conductive layer in predetermined areas of the resin layer surface and removing an unnecessary transparent conductive layer. For example, in manufacturing a liquid crystal display of a simple matrix structure, transparent electrodes are formed by leaving striped transparent conductive layers on the surface of the resin layer. In patterning the transparent conductive layer of the substrate of this type, photolithography and wet etching are mainly used.

A resist coating process and a mask forming process are necessary for photolithography. It is therefore not easy to shorten a process time. Chemicals are used for wet etching, so that waste liquid is generated. It is not therefore easy to lower an environmental load to be caused by wet etching.

### SUMMARY OF THE INVENTION

An object of this invention is to provide a novel laser processing method and a laser processing apparatus utilizing this method, the method and apparatus being capable of properly processing a transparent conductive layer made of metal oxide and formed on the surface of a resin layer.

According to one aspect of the present invention, there is provided a laser processing method comprising steps of: (a) irradiating a laser beam from a laser source; and (b) applying the laser beam irradiated from the laser source to a first surface area of a processing object having a resin layer and a transparent conductive layer made of metal oxide and formed on a surface of the resin layer, to remove the transparent conductive layer and form a first concave portion exposing the resist layer on a bottom of the first concave portion.

The novel laser processing method is provided by which the transparent conductive layer of the processing object (laminated target) having the transparent conductive layer made of metal oxide and formed on the surface of the resin layer, is removed by suppressing the resin layer from being damaged, and the concave portion is formed in the surface layer of the processing object. Accordingly, processes such as photolithography and wet etching conventionally used widely are not necessary, and it is possible to shorten a process time and lower an environmental load to be caused by processing.

According to another aspect of the present invention, there is provided a laser processing apparatus comprising: a laser source for irradiating a pulse laser beam having a wavelength of 240 nm to 340 nm and a pulse width of 1 ns to 60 ns; a beam cross section shaper for shaping the pulse laser beam irradiated from the laser source to have a beam cross section elongated in one direction on a surface of the processing object held by the holding mechanism; a transport mechanism for changing relative positions of the processing object and an incidence position of the pulse laser beam whose cross section was shaped by the beam cross section shaper, in response to an external control signal, so as to move the incidence position of the pulse laser beam on the surface of the processing object held by the holding mechanism; and a controller for controlling the transport mechanism to move a beam irradiation area on the surface of the processing object held by the holding mechanism to make the beam irradiation area to which one pulse laser beam irradiated from the laser source is applied, be spaced from the beam irradiation area to which another pulse laser beam is applied.

The laser processing apparatus can be used for processing, for example, a processing object having a resin layer and a transparent conductive layer made of metal oxide stacked on the resin layer. A pulse laser beam is applied to the surface of the processing object under proper conditions to remove the transparent conductive layer and form a first groove in the surface area of the processing object, while the resin layer is suppressed from being damaged. A second groove can be formed in another surface area of the processing object spaced from the surface area where the pulse laser beam was applied, by applying another pulse laser beam. Since the surface areas where different pulse laser beams are applied are spaced apart from each other, the resin layer forming the bottom of the groove can be prevented from being damaged, for example, by applying the pulse laser beam to the bottom of the already formed groove.

### BRIEF DESCRIPTION OF THE DRAWINGS

FIG. 1A is a cross sectional view of a processing object to be processed, and FIG. 1B is a schematic diagram of a laser processing apparatus according to an embodiment.

FIGS. 2A and 2B are cross sectional views showing an example of the structure of a homogenizer used with the laser processing apparatus shown in FIG. 1B.

FIG. 3 is a plan view of a processing object, illustrating a laser processing method according to an embodiment.

### DESCRIPTION OF THE PREFERRED EMBODIMENTS

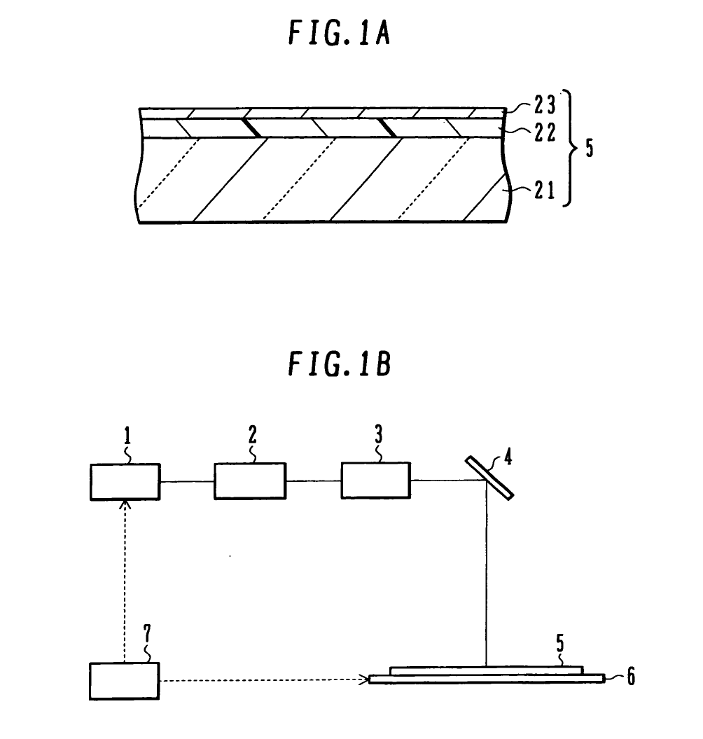

With reference to FIG. 1A, description will be made first on an example of an object capable of being processed by using the present invention. A resin layer 22 made of polyimide-based resin or acrylic-based resin having a thickness of, e.g., 1 μm is formed on the surface of a glass base 21 having a thickness of, e.g., 0.7 mm. A transparent conductive layer 23 is formed on the surface of the resin layer 22. The transparent conductive layer is made of metal oxide such as indium tin oxide (ITO) and SnO₂ having a thickness of, e.g., 0.5 μm. An object 5 to be processed is a lamination of the glass base 21, resin layer 22 and transparent conductive layer 23. The processed object 5 is used, for example, as a constituent component of a liquid crystal display. In a liquid crystal display, the resin layer 22 functions as, for example, a color filer. The transparent conductive layer 23 is used for forming transparent electrodes for generating an electric field across a liquid crystal layer.

There is a need for removing only portions of the transparent conductive layer 23 without damaging the resin layer 22 to form concave portions such as holes and grooves whose bottom surfaces expose the resin layer 22. The processing object 5 has a laminated structure that the transparent conductive layer 23 is stacked on the resin layer 22 having a higher optical absorption factor than that of the transparent conductive layer 23. Therefore, irradiated light transmits through the transparent conductive layer 23 and is absorbed in the resin layer 22. It is therefore anticipated that processing the object with laser is difficult. However, as will be described below, the present inventors have found the conditions that processing the object with laser can be performed properly.

The present inventors conducted experiments of irradiating pulse laser beams to the processing object 5, the pulse laser beams including fundamental wave (wavelength of 1064 nm), second order harmonic wave (wavelength of 532 nm), third order harmonic wave (wavelength of 355 nm), fourth order harmonic wave (wavelength of 266 nm), and fifth order harmonic wave (wavelength of 213 nm), respectively of yttrium aluminum garnet (YAG) laser. The object was able to be processed properly with fourth order harmonic wave of YAG laser but not with fundamental wave and second, third and fifth order harmonic waves.

The present inventors have had knowledge from the experiment results that it is preferable to irradiate laser having a wavelength of 240 nm to 340 nm between the wavelength of 213 nm of the fifth order harmonic wave of YAG layer and the wavelength of 355 nm of the third order harmonic wave.

Other conditions were also studied. The present inventors have had knowledge that the transparent conductive layer 23 can be processed without damaging the resin layer 22 by irradiating one shot of a laser beam having a pulse width of 1 ns to 60 ns. It has also be found that a pulse energy density on the surface of the processing object 5 is preferably set to 0.1 J/cm² to 0.4 J/cm². A diameter of a beam spot of YAG layer irradiated to the processing object 5 in the experiments was about 100 μm.

FIG. 1B is a schematic diagram of a laser processing apparatus according to an embodiment of the present invention. A laser source irradiates a pulse laser beam. The laser source 1 may be KrF excimer laser which irradiates a pulse laser beam having a wavelength of 248 nm and a pulse width of several ns to 60 ns or XeCl excimer laser which irradiates a pulse laser beam having a wavelength of 308 nm and a pulse width of 20 ns to 50 ns. An energy per one pulse is, for example, 15 J. A controller 7 controls the laser source 1 so that a laser beam pulse is irradiated at desired timings.

A laser beam irradiated from the laser source 1 passes through an expander 2 which expands a beam diameter and forms parallel light, and enters a homogenizer 3.

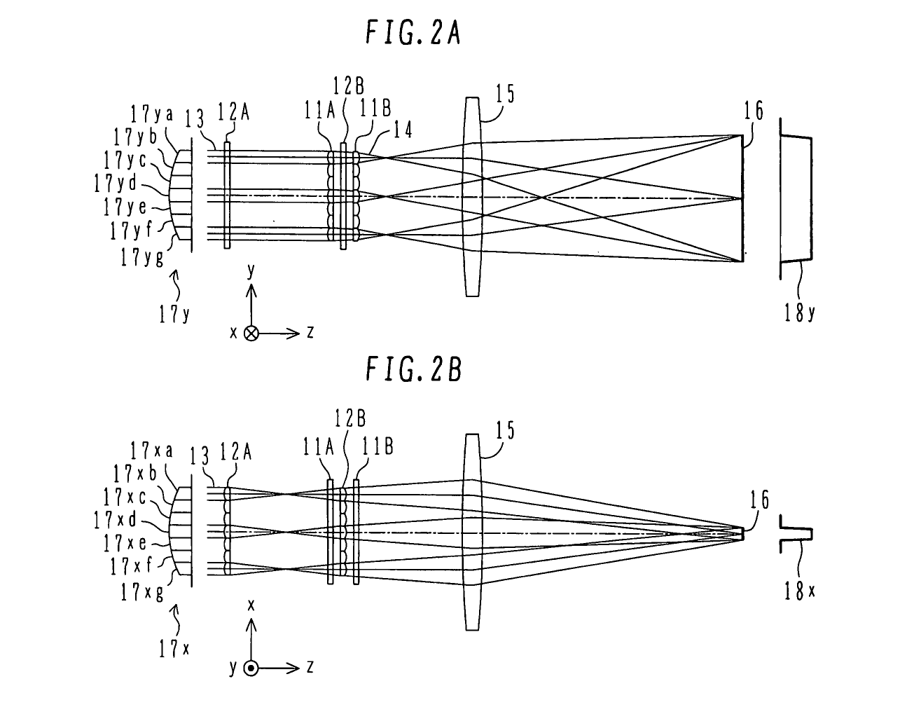

With reference to FIGS. 2A and 2B, description will be made on examples of the structure and operation of the homogenizer 3. Consider now an xyz rectangular coordinate system having a z-axis parallel to a propagation direction of a light flux incident upon the homogenizer 3. FIG. 2A is a cross sectional view parallel to a yz plane, and FIG. 2B is a cross sectional view parallel to an xz plane.

As shown in FIG. 2A, cylinder arrays 11A and 11B are disposed along virtual planes parallel to the xy plane. Each of the cylinder arrays has seven equivalent cylindrical lenses disposed along a y-axis, each having a generating line parallel to an x-axis. An optical axial plane of each cylindrical lens of the cylinder arrays 11A and 11B is parallel to the xz plane. The optical axial plane means a symmetrical plane of the cylindrical lens which focuses incident light in plane-symmetrical fashion. The cylinder array 11A is disposed on a light input side (left in FIG. 2A), and the cylinder array 11B is disposed on a light output side (right in FIG. 2A).

As shown in FIG. 2B, cylinder arrays 12A and 12B are disposed along virtual planes parallel to the xy plane. Each of the cylinder arrays has seven equivalent cylindrical lenses disposed along the x-axis, each having a generating line parallel to the y-axis. An optical axial plane of each cylindrical lens of the cylinder arrays 12A and 12B is parallel to the yz plane. The cylinder array 12A is disposed in front of (left in FIG. 2B) the cylinder arrays 11A, and the cylinder array 12B is disposed between the cylinder arrays 11A and 11B. The optical axial planes of corresponding cylindrical lenses of the cylinder arrays 11A and 11B are coincident, and the optical axial planes of corresponding cylindrical lenses of the cylinder arrays 12A and 12B are coincident.

A converging lens 15 is disposed after the cylinder array 11B. An optical axis of the converging lens 15 is parallel to the z-axis.

With reference to FIG. 2A, description will be made on a propagation state of a light flux along the yz plane. Since the cylinder arrays 12A and 12B in the yz plane are simply flat plates, optical convergence and divergence are not influenced. A parallel light flux 13 becomes incident upon the cylinder array 12A from the left of the cylinder array 12A, having a propagation direction parallel to the z-axis. The parallel light flux 13 has an optical intensity high in a central area and low in a peripheral area, for example, as indicated by a curve 17y.

The parallel light flux 13 transmits through the cylinder array 12A and becomes incident upon the cylinder array 11A. This incident light flux is separated into seven converged light fluxes corresponding to seven cylindrical lenses of the cylinder array 11A. In FIG. 2A, only the light fluxes at the middle and opposite ends are shown as representative light fluxes. The seven converged light fluxes have an optical intensity distribution indicated by curves 17ya to 17yg. The light fluxes converged by the cylinder array 11A are again converged by the cylinder array 11B.

The seven light fluxes 14 converged by the cylinder array 11B are converged to the maximum in front of the converging lens 15. This converging position is nearer to the converging lens 15 than a focal point of the lens on an input side. Therefore, seven light fluxes transmitted through the converging lens 15 change to diverged light fluxes, and are superposed on a homogenized plane 16. An optical intensity distribution along the y-axis direction of the seven light fluxes irradiated to the homogenized plane 16 is equal to the distribution obtained by elongating the optical intensity distribution indicated by curves 17ya to 17yg along the y-axis direction. The optical intensity distributions 17ya and 17yg, 17yb and 17yf, and 17yc and 17ye have a reversed relation relative to the y-axis direction. Therefore, the optical intensity distribution of superposed these optical fluxes has generally a uniform distribution as indicated by a curve 18y.

With reference to FIG. 2B, description will be made on a propagation state of a light flux along the xz plane. Since the cylinder arrays 11A and 11B in the xz plane are simply flat plates, optical convergence and divergence are not influenced. The parallel light flux 13 becomes incident upon the cylinder array 12A. The parallel light flux 13 has an optical intensity high in a central area and low in a peripheral area, for example, as indicated by a curve 17x.

The parallel light flux 13 is separated into seven converged light fluxes corresponding to seven cylindrical lenses of the cylinder array 12A. In FIG. 2B, only the light fluxes at the middle and opposite ends are shown as representative light fluxes. The seven converged light fluxes have an optical intensity distribution indicated by curves 17xa to 17xg.

Each light flux is converged to the most in front of the cylinder array 12B, and thereafter changed to diverged light fluxes which become incident upon the cylinder array 12B. Each light flux incident upon the cylinder array 12B outputs at a certain output angle and enters the converging lens 15.

The seven light fluxes transmitted through the converging lens 15 are changed to converged light fluxes, and superposed on the homogenized plane 16. Similar to FIG. 2A, an optical intensity distribution along the x-axis direction of the seven light fluxes irradiated to the homogenized plane 16 has a uniform distribution indicated by a solid line 18x.

As described above, the homogenizer 3 operates to make an optical irradiation area on the homogenized plane 16 have a stripe shape long along the y-axis direction and short along the x-axis direction, and to make generally uniform the optical intensity distribution in the optical irradiation area on the homogenized plane 16.

Description will be made by reverting to FIG. 1B. A laser beam irradiated from the homogenizer 3 is reflected by a return mirror 4, and becomes incident upon the processing object 5 described with reference to FIG. 1A. Relative positions of the homogenizer 3 and processing object 5 are adjusted beforehand so as to make the surface of the processing object 5 be coincident with the homogenized plane. A stripe area, for example, 1100 mm long and 1 mm wide on the surface of the processing object, can be exposed generally uniformly by one shot laser irradiation. A pulse energy density on the surface of the processing object 5 is, for example, 0.4 J/cm².

The processing object 5 is held on an XY stage 6. The XY stage 6 is used for moving the processing object on a plane parallel to the surface of the processing object. The controller 7 controls the XY stage 6 in such a manner that the processing object 5 is located at a desired position at a desired timing.

The laser source 1 and XY stage 6 are controlled by the controller 7 in such a manner that the laser source and XY stage operate synchronously. A laser beam pulse is irradiated when the processing object 5 is located at a desired position.

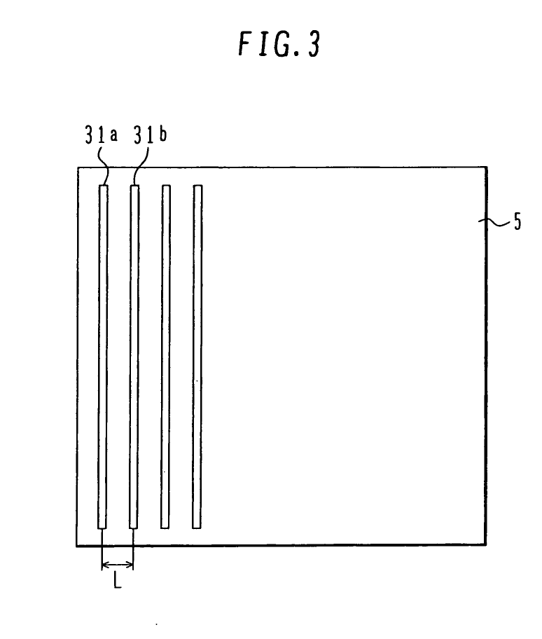

Next, with reference to FIG. 3, description will be made on a laser processing method of forming stripe-shaped grooves in the surface layer of a processing object at a constant pitch L between centers of adjacent grooves, by using the above-described laser processing apparatus. FIG. 3 is a plan view of a processing object 5. The first shot of a pulse laser beam is irradiated to the surface of the processing object 5. Since the beam cross section is shaped in a stripe shape by the homogenizer, an optical irradiation area 31a of a stripe shape on the surface of the processing object is exposed to laser. Irradiation of the first shot removes the transparent conductive layer 23 in the optical irradiation area 31a to form a first groove exposing the resin layer 22 on the bottom thereof.

After the first groove is formed, the XY stage is moved by a length L along a direction perpendicular to the longitudinal direction of the beam cross section on the plane parallel to the surface of the processing object 5. The length L is longer than the width of the beam cross section on the surface of the processing object.

Next, the second shot of the pulse laser beam is irradiated. An optical irradiation area 31b of a stripe shape on the surface of the processing object is exposed to laser. Since the pitch L between the centers of adjacent grooves is longer than the width of the beam cross section, the optical irradiation area 31a and optical irradiation area 31b are spaced by a predetermined distance. Irradiation of the second shot removes the transparent conductive layer 23 in the optical irradiation area 31b to form a second groove exposing the resin layer 22 on the bottom thereof.

Similarly, the processing object 5 is moved by the length L along the direction perpendicular to the longitudinal direction of the beam cross section, and one shot of a pulse laser beam is irradiated. This operation is repeated to form linear grooves at the constant pitch L between centers of adjacent grooves.

As described above, the transparent conductive layer 23 is removed by irradiating a laser beam under proper conditions to the processing object 5 such as described with reference to FIG. 1A. It is therefore possible to form the groove exposing the resin layer 22 on the bottom thereof in the surface layer of the processing object, while the resin layer 22 is suppressed from being damaged.

The resin layer exposed on the bottom of the groove can be prevented from being damaged by irradiating again the pulse laser beam to the bottom of the same groove, because the optical irradiation areas to be exposed with different pulse laser beams are spaced by the predetermined distance.

The following method has been used widely to form a groove by irradiating a pulse laser beam. An area on the surface of a processing object where a groove is to be formed, is divided into a plurality of partial areas. A pulse laser beam is irradiated to each partial area to form a concave portion, and concave portions are made continuous to form one groove. If this method of forming each concave portion is used, it is difficult to improve linearity of the edges of an opening of a groove along the longitudinal direction of the groove.

According to the laser processing method of the embodiment, a groove is formed in the surface layer of the processing object by irradiating one shot of a pulse laser beam to an area corresponding to the groove, the laser beam having the beam cross section shaped in a stripe shape. The shape of an opening of the groove is in conformity with the stripe-shaped beam cross section. Parallel edges of the beam cross section along the longitudinal direction shaped by the homogenizer have high linearity. It is therefore possible to improve linearity of the edges of the opening of a groove along the longitudinal direction. Since the groove can be formed only by one shot, a process time can be shortened.

Although grooves are formed at the constant pitch L between centers of adjacent grooves, the grooves may be formed at different pitches between centers of adjacent grooves.

Although the groove is formed by shaping the beam cross section in a stripe shape, the beam cross section may be shaped in other shapes. Concave portions can be formed which have openings corresponding to the beam cross sectional shape.

The expander 2 and homogenizer 3 of the laser processing apparatus shown in FIG. 1B may be omitted to form a concave portion in the processing object 5 by using harmonic wave solid state laser such as the harmonic wave YAG laser used by the above-described experiments.

Although the laser beam irradiation area on the surface of the processing object is moved by moving the XY stage, the laser beam irradiation area may be moved by scanning the propagation direction of a laser beam with a galvano-scanner or the like.

A conventional method of patterning a transparent conductive layer requires a resist coating process and mask forming process for photolithography. Further, waste liquid is generated during wet etching. According to the laser processing method of the embodiment, both photolithography and wet etching are not necessary for patterning a transparent conductive layer. It is therefore possible to shorten a process time and lower an environmental load to be caused by processing.

The present invention has been described in connection with the preferred embodiments. The invention is not limited only to the above embodiments. It will be apparent to those skilled in the art that other various modifications, improvements, combinations, and the like can be made.

What we claim are:

1. A laser processing method comprising steps of:
(a) irradiating a laser beam from a laser source; and
(b) applying the laser beam irradiated from said laser source to a first surface area of a processing object having a resin layer and a transparent conductive layer made of metal oxide and formed on a surface of said resin layer, to remove said transparent conductive layer and form a first concave portion exposing said resist layer on a bottom of said first concave portion.

2. The laser processing method according to claim 1, further comprising, after said step (b), a step of applying the laser beam irradiated from said laser source to a second surface area of said processing object spaced apart from said first surface area, to remove said transparent conductive layer and form a second concave portion exposing said resist layer on a bottom of said second concave portion.

3. The laser processing method according to claim 1, wherein said laser source irradiates a pulse laser beam having a wavelength of 240 nm to 340 nm and a pulse width of 1 ns to 60 ns.

4. The laser processing method according to claim 2, wherein said laser source irradiates a pulse laser beam having a wavelength of 240 nm to 340 nm and a pulse width of 1 ns to 60 ns.

5. The laser processing method according to claim 3, wherein a pulse energy density of the pulse laser beam to be applied to the surface of said processing object is 0.1 J/cm² to 0.4 J/cm² at an optical irradiation surface of said processing object.

6. The laser processing method according to claim 4, wherein a pulse energy density of the pulse laser beam to be applied to the surface of said processing object is 0.1 J/cm² to 0.4 J/cm² at an optical irradiation surface of said processing object.

7. The laser processing method according to claim 1, wherein said step (b) includes a step of shaping a cross section of the pulse laser beam irradiated from said laser source to make a beam cross section have an elongated shape in one direction on a surface of said transparent conductive layer.

8. The laser processing method according to claim 2, wherein said step (b) includes a step of shaping a cross section of the pulse laser beam irradiated from said laser source to make a beam cross section have an elongated shape in one direction on a surface of said transparent conductive layer.

9. The laser processing method according to claim 3, wherein said step (b) includes a step of shaping a cross section of the pulse laser beam irradiated from said laser source to make a beam cross section have an elongated shape in one direction on a surface of said transparent conductive layer.

10. The laser processing method according to claim 4, wherein said step (b) includes a step of shaping a cross section of the pulse laser beam irradiated from said laser source to make a beam cross section have an elongated shape in one direction on a surface of said transparent conductive layer.

11. The laser processing method according to claim 5, wherein said step (b) includes a step of shaping a cross section of the pulse laser beam irradiated from said laser source to make a beam cross section have an elongated shape in one direction on a surface of said transparent conductive layer.

12. The laser processing method according to claim 6, wherein said step (b) includes a step of shaping a cross section of the pulse laser beam irradiated from said laser source to make a beam cross section have an elongated shape in one direction on a surface of said transparent conductive layer.

13. A laser processing apparatus comprising:
a holding mechanism for holding a processing object;
a laser source for irradiating a pulse laser beam having a wavelength of 240 nm to 340 nm and a pulse width of 1 ns to 60 ns;
a beam cross section shaper for shaping the pulse laser beam irradiated from said laser source to have a beam cross section elongated in one direction on a surface of the processing object held by said holding mechanism;
a transport mechanism for changing relative positions of the processing object and an incidence position of the pulse laser beam whose cross section was shaped by said beam cross section shaper, in response to an external control signal, so as to move the incidence position of the pulse laser beam on the surface of the processing object held by said holding mechanism; and
a controller for controlling said transport mechanism to move a beam irradiation area on the surface of the processing object held by said holding mechanism to make the beam irradiation area to which one pulse laser beam irradiated from said laser source is applied, be spaced from the beam irradiation area to which another pulse laser beam is applied.
